(19) United States
(12) Patent Application Publication
(10) Pub. No.: US 2013/0328333 A1
(43) Pub. Date: Dec. 12, 2013

(54) Vehicle Door Bumper Guard having Door Edge Attachments

(71) Applicant: Joshua Jordan, Brooklyn, NY (US)

(72) Inventor: Joshua Jordan, Brooklyn, NY (US)

(21) Appl. No.: 13/913,573

(22) Filed: Jun. 10, 2013

Related U.S. Application Data
(60) Provisional application No. 61/658,267, filed on Jun. 11, 2012.

(51) Int. Cl. B60R 13/04

(52) U.S. Cl. CPC B60R 13/04
USPC 293/128

(57) ABSTRACT

A vehicle door bumper guard device is provided that includes either a temporary or permanent fixture for attachment between two adjacent door edges of a vehicle. The device comprises an elongated, hollow structure surrounded by an energy attenuating material, which is supported by an elastic strap fed through the interior of the structure. The ends of the strap terminate at a door edge clip, which can be temporarily fixed around a door edge or mechanically fastened thereto. The device includes formed ends to promote aerodynamics when applied in a permanent configuration, and is constructed of relatively inexpensive material to promote producibility but retaining durability.

### CROSS REFERENCE TO RELATED APPLICATION

This application claims the benefit of U.S. Provisional Application No. 61/658,267 filed on Jun. 11, 2012, entitled “Side Door Molding.” The above identified patent application is herein incorporated by reference in its entirety to provide continuity of disclosure.

### BACKGROUND OF THE INVENTION

1. Field of the Invention

The present invention relates to automobile door protectors and aftermarket door moldings that protect against impacts from adjacent vehicle doors in parking lot areas. More specifically, the present invention pertains to a permanent or temporary door bumper fixture applied across a vehicle door to prevent a neighboring vehicle door from impacting the vehicle door and damaging its paint and structure.

Along with maintaining the functional and utilitarian aspects of an automobile, many individuals take great pride in the outward appearance of their vehicle and takes steps to protect its exposed surfaces from damage. Automobiles are expensive personal property, and most individuals expend considerable effort to care for and maintain the vehicle over the course of its ownership. While work vehicles or purely functional vehicles may not be as prized as more exotic or personal vehicles, and thus may be less maintained from an outward perspective, no one is interested in making repairs to their vehicle when the damage thereto could have otherwise been avoided or reduced.

Many aftermarket products exist for maintaining a vehicle exterior appearance and for preventing damage to the exterior body. These include car covers, car shades, car bras, plastic sealants, bumper guards, and many other fixtures that shield the paint and bodywork. Of particular interest to the present invention is the area of bumper guards for vehicle doors. A common situation experienced by most is the parking lot environment, where cars are aligned and parked in close proximity to one another and left unattended for periods of time. An owner's vehicle becomes vulnerable and exposed to being scratched or dinged by a neighboring vehicle door or shopping cart while the car is left parked and not monitored.

To prevent this type of damage, many individuals deploy a form of barrier along their car exterior or order their vehicles equipped with door bumper strips that run along the length of each door. In the case of aftermarket bumpers, these are usually awkward to apply and thus are not always deployed when necessary. For vehicles equipped with bumper strips along their doors, these fixtures are generally painted and a visible party of the vehicle. Replacing them after being dinged or scratched can be just as big of a headache for the owners as having the door panel itself repaired. A new solution is therefore required that provides a readily deployable bumper guard for a vehicle door or for the whole side of a vehicle, wherein the device protects the vehicle and is not cumbersome so as to inhibit regular use.

The present invention comprises such a door bumper guard, which is operably deployable when an owner leaves his vehicle unattended, or is provided as a permanent fixture that is applied once and left on the vehicle over its lifetime. The device comprises an elongated bumper member having a cross section defined by a rounded, open member having an outer elastic covering. Within the interior of the elongated member is an elastic strap that extends from the ends of the member and terminates at door clips on either end to secure over opposite edges of the door. The clips are either permanently fastened by way of rivets to the door, or operably applied over the door edges when the user leaves the car unattended. The structure of the bumper is such that it absorbs impacts and prevents damage to the paint and outer shell of the door when impacted by a neighboring door edge, shopping cart, or similar structure that may otherwise create damage.

2. Description of the Prior Art

Devices have been disclosed in the prior art that relate to door bumper guards and vehicle protectors. These include devices that have been patented and published in patent application publications. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 4,991,891 to Karshens discloses a removable and locking side guard for a vehicle, wherein the device includes an elongated and tubular design for protecting against dings and scratches. The device is locked into placed along the wheel well arches and may include electrical connectivity to the vehicle's alarm system if removed without authorization. The lock is deactivated using the vehicle door locks. While describing a door bumper, the Karshens device is secured to the wheel arches as opposed to the door gaps between the body and door edges of the vehicle.

Several other door bumper guards are disclosed that protect a vehicle door, however these are adhered to or otherwise fastened to the door panel itself. These include U.S. Pat. No. 4,235,466 to Mandrik, U.S. Pat. No. 4,398,758 to Tabares, U.S. Pat. No. 5,267,763 to Klein, U.S. Pat. No. 3,506,294 to Newman, and finally U.S. Pat. No. 3,309,129 also to Newman. These devices provide outward protection for a door, where an energy attenuating member or disposable strip are provided in connection with the vehicle exterior to prevent direct contact between an adjacent door edge and the vehicle being protected. These devices require fasteners or adhesive to apply to the door, thereby causing alterations to the vehicle, damage to the paint and clear coating, or at a minimum making them difficult to apply and remove with regularity.

The present invention, by contrast, is readily applied when a user leaves his car unattended, or is applied using mechanical fasteners along the interior of the door edge to prevent any exterior body damage or rust concerns with regard to permanently fastening the device to a vehicle door. The present invention, in its removable embodiment, is placed between opposing door edges and in between the door edge and an adjacent body panel to support the energy absorbing member across the door length. A band between the opposing clips secures an exterior door barrier that prevents dings, scratches, and impacts with adjacent car doors being opened.

While other door protectors exist in the art related to attachable fixtures, the present invention provides a new and novel construction for a door bumper guard, wherein a permanent and a temporary fixture are disclosed. It is submitted that the present invention is substantially divergent in design elements from the prior art, and consequently there is a clear need in the art for an improvement to existing vehicle door bumper guard devices. In this regard the instant invention substantially fulfills these needs.

### SUMMARY OF THE INVENTION

In view of the foregoing disadvantages inherent in the known types of vehicle door bumper guard devices now present in the prior art, the present invention provides a new bumper guard fixture that is supported by opposing vehicle door edges and can be applied temporarily or as a permanent fixture, providing convenience for the user when protecting a vehicle door from damage from adjacent door and shopping cart impacts therewith.

It is therefore an object of the present invention to provide a new and improved vehicle door bumper guard device that has all of the advantages of the prior art and none of the disadvantages.

It is another object of the present invention to provide a vehicle door bumper guard device that can be deployed in either a temporary or permanent configuration, wherein the temporary configuration spans the side of the vehicle and is operably mounted by the user upon exiting the vehicle, while the permanent configuration is attached across a singled door and is mechanically fastened to the interior door edge.

Another object of the present invention is to provide a vehicle door bumper guard device that includes a hollow, semi-rigid bar surrounded by an energy absorbing layer therearound to absorb impacts when deployed.

Yet another object of the present invention is to provide a vehicle door bumper guard device that is comprised of materials that promote economy and ease of manufacturing, while also being sufficient for vehicle exterior use where the material will not cause damage to the vehicle or readily deteriorate when exposed to sun, rain, and other outdoor elements.

Another object of the present invention is to provide a vehicle door bumper guard device that includes an attachment means that is supported by opposing door edges and is capable of being applied to most any brand or make vehicle without major changes.

Another object of the present invention is to provide a vehicle door bumper guard device that includes formed ends to promote aerodynamic efficiency when permanently applied to a vehicle.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the device in a working state across a vehicle door.

FIG. 2 shows an exemplary cross section of the door bumper device.

FIG. 3 shows a view of an embodiment of the door edge clip for temporary fixing the device between a door edge and door body panel.

FIG. 4 shows a view of the door edge clip of the device, wherein the clip is placed between a door edge and an adjacent body panel as the door is closed to temporarily affix the clip to the vehicle, which can be further fastened to the door edge backside for permanent connection therewith.

FIG. 5 shows an overhead view of the device in an operating condition.

FIG. 6 shows an embodiment of the door bumper device and its flexibility with respect to the vehicle door exterior shape.

FIG. 7 shows a view of the device in a working state applied to a single door.

FIG. 8 shows a view of the device in a working state applied across multiple doors.

### DETAILED DESCRIPTION OF THE INVENTION

Reference is made herein to the attached drawings. Like reference numerals are used throughout the drawings to depict like or similar elements of the vehicle door bumper guard device. For the purposes of presenting a brief and clear description of the present invention, the preferred embodiment will be discussed as used for protecting the exterior surface of a vehicle body from impacts with external objects, such as car doors and shopping carts. The figures are intended for representative purposes only and should not be considered to be limiting in any respect.

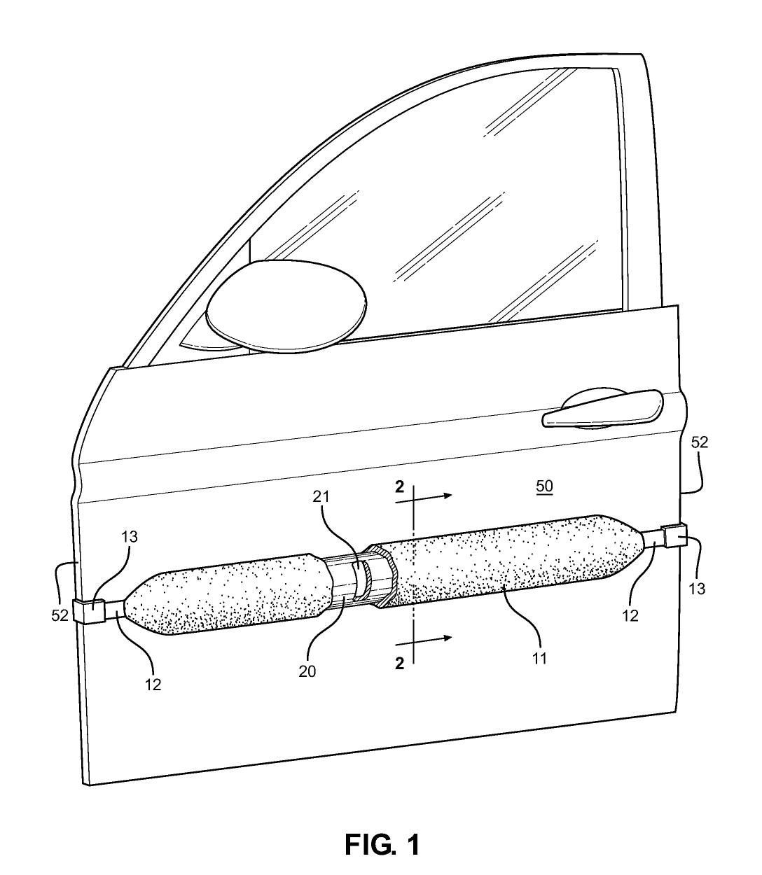

Referring now to FIG. 1, there is shown a perspective view of the vehicle door bumper guard device of the present invention in a working state, applied across a vehicle door surface 50 to protect the door from dings, dents, and impacts from environmental objects. The device comprises an elongated bumper member 11 having a leading and trailing end, which is supported by an elongated, elastic strap 12 that spans across the door 50 and through the member 11 to maintain the bumper member 11 in position against the door 50. The strap 12 is tensioned between two opposing clips 13, which are adapted to conform around the edges 52 of the door 50 and maintain a static position therealong such that the weight of the bumper member 11 does not cause the clips to slide or the bumper to shift position after the device is deployed.

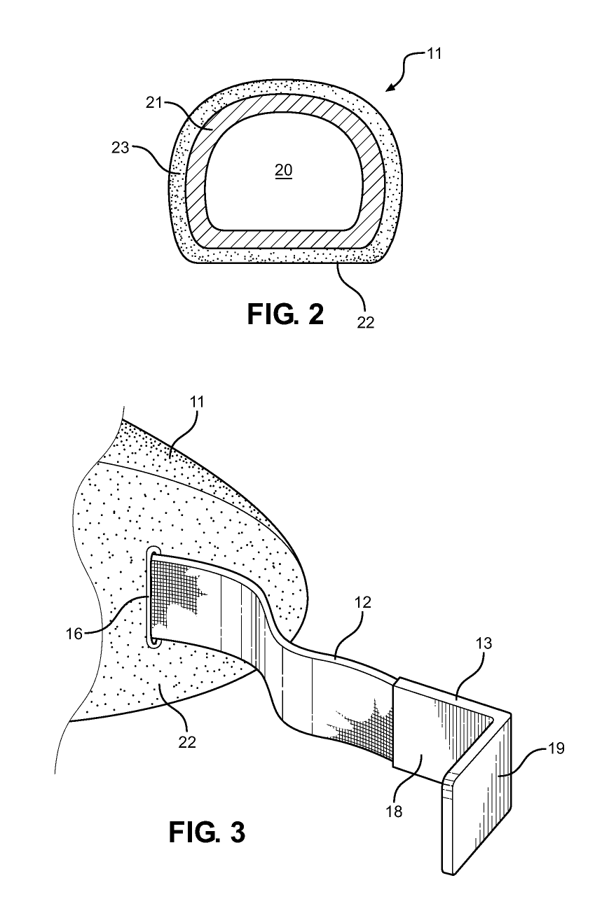

Referring to FIGS. 1 and 2, the cross section of the device comprises an inner hollow member 21 having a flat base 22 and a rounded outer portion. The open interior 20 of the hollow member 21 accommodates the supporting strap 12 placed therethrough, while the flat base 22 is adapted to rest against the relatively flat outer surface of a vehicle door 50 in the vehicle fore-aft direction. The round outer construction of the device also allows the member to absorb impacts and provide a cross section that can deform when in a predictable and controlled manner when loaded, whereby the flat base is pressed against the door surface 50 while the outer, rounded portion can undergo a temporary deformation.

Surrounding the inner hollow member 21 is an energy attenuating outer layer 23. The outer layer 23 provides a cushioned outer surface for the device such that impacts are not directly absorbed by the door surface 50, but are attenuated first through deformation of this outer layer. The immediate impact zone causes a deformation of the outer layer 23, while the base surface 22 can then deform before loading the inner member 21 or placing any significant load against the door 50. The outer layer 23 is preferably a foam or similar compressible material that undergoes ready deformation upon an impact with another object, such as a door edge or shopping cart.

Referring now to FIG. 3, there is shown a view from one end of the bumper guard member, wherein the base surface 22 is shown and the preferred shape of the member end is highlighted. In a preferred embodiment, the ends are provided having a tapering shape to promote aerodynamics if the bumper guard device is left on the vehicle while driving. These ends close out the otherwise open ends of the hollow inner member allow wind to pass over the device with minimal drag. The base surface 22 includes outlet slits 16 that accept the elastic support strap 12 therethrough, wherein the strap is supported within the interior of the inner member of the bumper guard. The elastic strap 12 is adjustable by way of strap adjusters (not shown), while the strap ends terminate at a door edge clip 13.

The door edge clip 13 may be provided in a temporary or permanently fastened configuration, and may be designed to promote ease of application and removal between uses, or alternatively to be adapted to permanently apply to the vehicle exterior. FIG. 3 shows the simplest embodiment of the clip 13, wherein an L-shaped clip member 13 is provided having a first section 18 that connects to the strap 12 end and a second section 19 that is mounted perpendicularly inward towards the vehicle such that that the second section can be slid between a door edge and an adjacent vehicle body panel. This embodiment is most useful for temporary and rapid placement of the device against a vehicle exterior, as the clips can be applied when the vehicle doors are closed, slid between body panels and tensioned in place. However, this embodiment offers little in the way of security while the owner is not monitoring the vehicle, as the device can be readily removed. This embodiment is ideal in gated parking garages, in private or workplace parking lots, or in other relatively secure parking environments.

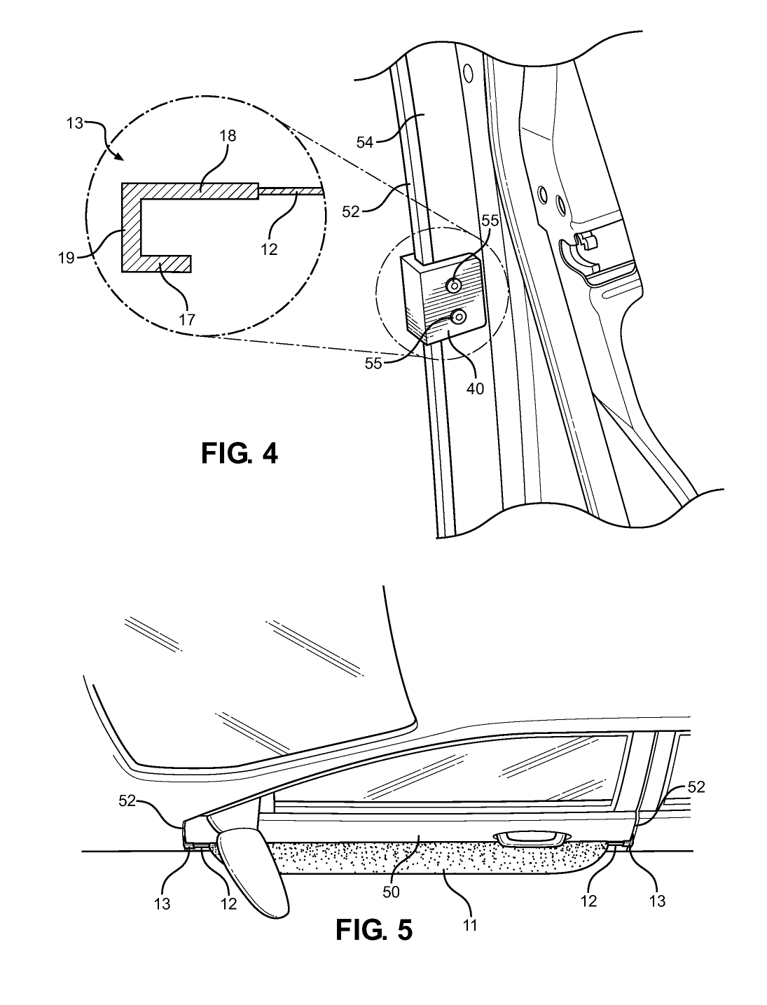

Referring now to FIG. 4 there is shown a preferred embodiment of the device end clip 13 and an embodiment that contemplates permanent connection to a vehicle door. In this embodiment of the clip 13, the clip comprises a substantially U-shaped construction having a first section 18 to receive the strap 12 end, a perpendicular second section 19, and a return flange 17 along the end of the section to form an open U-section. The perpendicular second section is placed over a door edge 52 while the return flange 17 accepts the door edge into the clip interior. The door edge interior surface 54 prevents the clip from being removed when the door is closed and locked, which adds a layer of security. However, this also requires the user to apply the clip 13 when the door is ajar to obtain access to the door edge when fitting the clip 13.

In a preferred embodiment, the clip 13 is positioned against the door edge and then the door is shut, providing a temporary fixture along the door exterior that is not readily removable until the vehicle owner returns and re-opens the door. In an alternate embodiment, the clip can be permanently affixed to the door edge 52 and be considered a permanent vehicle fixture. Mechanical fasteners 55, such as screws or rivets, can be secured through the clip return flange to secure the clip 13 to the door, whereby the strap 12 is supported by the clip 13 in a permanent fashion and is not readily removable.

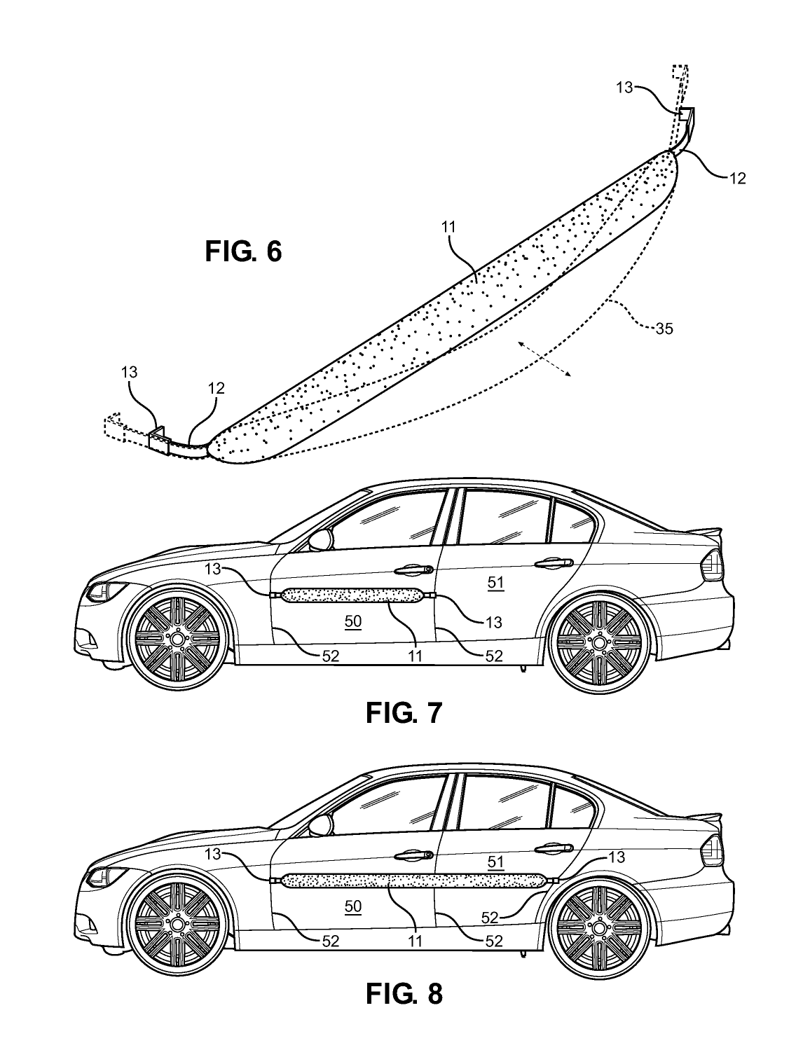

Referring now to FIG. 5, there is shown an overhead view of the bumper guard device of the present invention in a working state, applied across a vehicle door 50 and supported by opposing clips 13 and a strap 12 tensioned between two door edges 52. As shown in FIG. 6, the elongated inner member preferably comprises an elastic structure, such as a plastic or similar impact material that can be bowed 35 slightly inward and outward. The ability to change the profile of the elongated member 11 allows the device to conform to the outer surface of a vehicle, should the vehicle have flaring panels or non-planar surfaces.

Referring now to FIGS. 7 and 8, there are shown two configurations for deployment of the present invention. In FIG. 7, the device spans a single vehicle door 50 and attaches to opposing door edges 52 across its exposed exterior surface to prevent dings and dents. This embodiment may be temporarily applied or permanently affixed, as the normal operation of the door is not altered if the device is mechanically fastened to the door by way of fastened end clips 13. In FIG. 8, the device spans the length of the vehicle side and across front 50 and rear 51 doors to provide a great cover area against impacts. In this embodiment, the normal operation of the doors is altered, whereby the doors cannot be opened without first removing the device from its clip 13 attachments to the door edges 52. Therefore, this elongated embodiment is a temporary fixture that is deployed when the vehicle is not in use and parked for long periods of time.

Overall, the device provides a means of protecting the exterior paint and bodywork of a vehicle door by spanning a deformable bumper guard along its length. The bumper guard intercepts adjacent car door edges and inbound shopping carts and prevents direct impacts against the door exterior. This preserves the vehicle exterior and eliminates the need for expensive paint and bodywork repairs after one's vehicle is dinged or dented in a parking lot. The device is preferably an elongated, hollow member having a plastic or metallic interior member and a foam outer layer, wherein the device is supported by an elastic strap and supported by opposing door edges by way of clips.

When cars, trucks, vans, or any other type of vehicle are parked too closely together, people may accidentally hit the vehicle beside them when opening their door. This can cause scratches and dents to the parked car, and can also peel or transfer paint to both cars. People typically do not notice these scratches or dents until the next day when it is too late to get the other driver's insurance information. Additionally, it can be expensive to get any sort of work done on a vehicle, even small scratch and dent repairs.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) Vehicle door bumper guard device, comprising:
an elongated bumper member having an inner hollow member comprising a first and second end, a flat base and a rounded outer portion;
said hollow member having an outer energy attenuating layer;
an elongated strap extending through said inner hollow member;
said elongated strap having a first and second door edge clip at its terminal ends;
said door edge clips adapted to be positioned over a door edge and between a door edge and an adjacent vehicle body panel;
said elongated strap adapted to be tensioned between said clips and support said bumper member against a vehicle door outer surface.

2) The device of claim 1, wherein said door edge clips comprise L-shaped members having a first section and a perpendicular second section, said perpendicular second section adapted to be placed between a vehicle door edge and an adjacent vehicle body panel.

3) The device of claim 1, wherein said door edge clips comprise substantially U-shaped members having a first section, a perpendicular second section, and a return flange, said U-shaped member is adapted to be positioned over a vehicle door edge.

4) The device of claim 1, wherein said door edge clips comprise substantially U-shaped members having a first section, a perpendicular second section, and a return flange, said U-shaped member is adapted to be positioned over a vehicle door edge and mechanically fastened thereto.

5) The device of claim 1, wherein said inner hollow member comprises a metallic material.

6) The device of claim 1, wherein said inner hollow member comprises a plastic material.

7) The device of claim 1, wherein said outer energy attenuating layer comprises a foam material.

8) The device of claim 1, wherein said elongated bumper member first and second end further comprise tapered sections that enclose said inner hollow member.
